(19) United States
(12) Patent Application Publication
(10) Pub. No.: US 2002/0152187 A1
(43) Pub. Date: Oct. 17, 2002

(54) Expert system for intelligent teaching

(75) Inventor: Chung-Fang Chien, Taipei Hsien (TW)

Correspondence Address: LOWE HAUPTMAN GOPSTEIN, GILMAN & BERNER, LLP, Suite 310, 1700 Diagonal Road, Alexandria, VA, 22314, US

(73) Assignee: Netgenie Information Corporation

(21) Appl. No.: 09/835,637

(22) Filed: Apr. 17, 2001

(51) Int. Cl. G06F 17/00

(52) U.S. Cl. 706/60

(57) ABSTRACT

A computer-implemented method for helping a learner practice by providing hints is described. A simple question is provided to a learner. A decision is made on whether a hint is to be provided to the learner. A hint is provided to the learner if the decision is “yes”. A learner-given answer is received from the learner. The correctness of the learner-given answer is checked.

### FIELD OF THE INVENTION

This invention is directed to software and, more particularly, to a teaching system.

### BACKGROUND OF THE INVENTION

In a traditional teaching process, students are usually taught by only one teacher. Sometimes such a teaching process is limited by time, and sometimes by the number of the students. Due to those limitations, a teacher cannot simultaneously match up the rates of understanding and the responses from different students, and therefore cannot instruct each of the students according to his or her own “blind spot”. Such a teaching process often fails to enable students thoroughly understand and cannot achieve the purpose of teaching.

Two kinds of systems for computer-assisted instructions (CAI) have been presently developed. In one of them, teaching materials are directly input into a computer, and static pictures are input for assistance. To a user, such a system is not substantially different from a textbook or a reference book. This kind of system is widely used for network teaching now.

In another one of the systems, a complete idea is composed of animation, and the animation is displayed from beginning to end like video is played. Although such animation can be displayed again and again, a user can not effectively learn therefrom for not being able to locate his or her “blind spot” through such a repeated displaying process. Moreover, the system having such animation does not interact with the user well enough, and can not have the user's attention for long.

Accordingly, prior art teaching systems do not adequately provide interaction between themselves and the user, and are not suitable for students having different aptitudes. For at least the foregoing reasons, there is a need for a system teaching a student in accordance with their aptitudes.

### SUMMARY OF THE INVENTION

It is an object of this invention to provide a system teaching a student in accordance with his or her aptitudes.

Other objects and advantages of this invention will become apparent to those of ordinary skill in the art having reference to the following specification in conjunction with the drawings.

The invention may be incorporated into a computer-implemented method for helping a learner practice by providing hints is described. A simple question is provided to a learner. A decision is made on whether a hint is to be provided to the learner. A hint is provided to the learner if the decision is “yes”. A learner-given answer is received from the learner. The correctness of the learner-given answer is checked.

### BRIEF DESCRIPTION OF THE DRAWINGS

FIG. 1 to FIG. 5 schematically illustrate various pictures corresponding to different stages in a teaching process according to the present invention.

FIG. 6 to FIG. 13 are flow charts schematically illustrating operations for the first example of the present invention

FIG. 14 is a flow chart schematically illustrating an operation for the second example of the present invention.

FIG. 15 is another process flow schematically illustrating an operation for the second example the present invention.

FIG. 16 is the other flow chart schematically illustrating an operation for the second example of the present invention.

### DETAILED DESCRIPTION OF THE PREFERRED EMBODIMENT

In the following, this invention will be explained in more detail with reference to application examples illustrated by figures.

A general learning process is essentially divided into a teaching stage and an exercising stage. Similarly, a system according to the present invention is also, for example, divided into the two stages.

A. Teaching Process (Multimedia and Step-by-Step Teaching)

The way of displaying is as follows:

1. The content of a class (knowledge) for teaching is divided into several key steps.

2. Each of the steps is accompanied with a display of a scene or a practical operation to enrich the learning process.

3. In each of the steps, the student controls the rate of progress by himself according to his or her learning status. By the self-controlling, the student gets into the next step after he or she adequately understands the content of learning, no matter how long it takes him or her to understand.

4. If a student does not understand after he learns, he or she can learn again and again and step by step until he or she has fully understood. The way of displaying has the following advantages:

(1) A concept is divided into a plurality of displaying steps. Each of the steps is encoded with visual imagery and/or verbal mnemonics, thus enriching the learning purpose.

(2) By following step-by-step instructions, a student becomes aware of his or her own “blind point”.

(3) Operating the system by himself or herself, a student is interested in the learning process and is concentrated thereon.

A process of teaching a concept of a mathematics number line, for example, is described as follows:

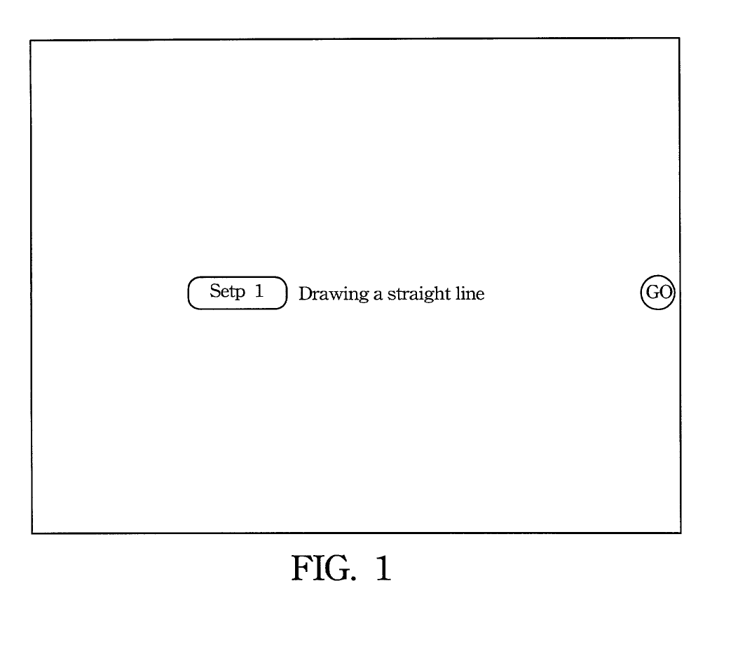

As shown in FIG. 1, a picture consisting of “Step 1 Draw a straight line GO” is displayed. The student is invited to process the button “GO”.

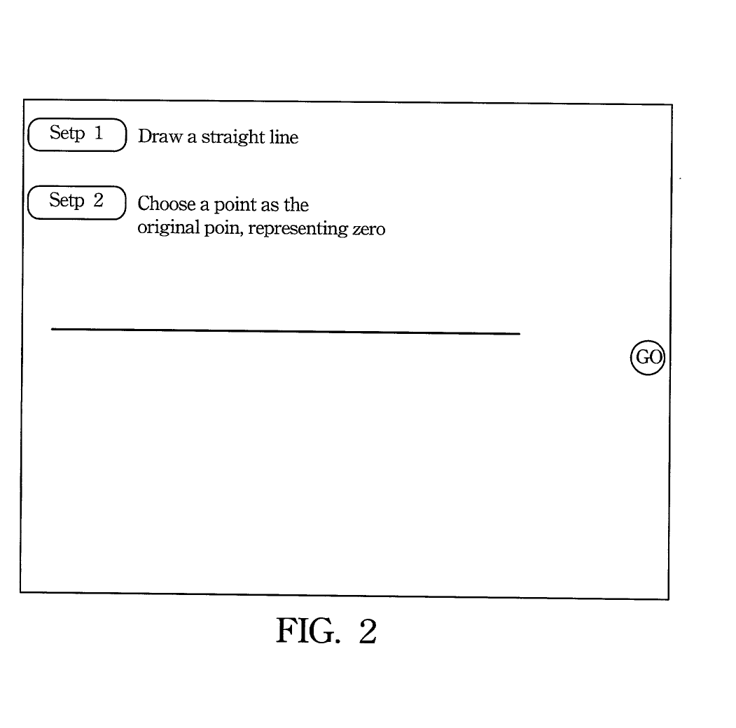

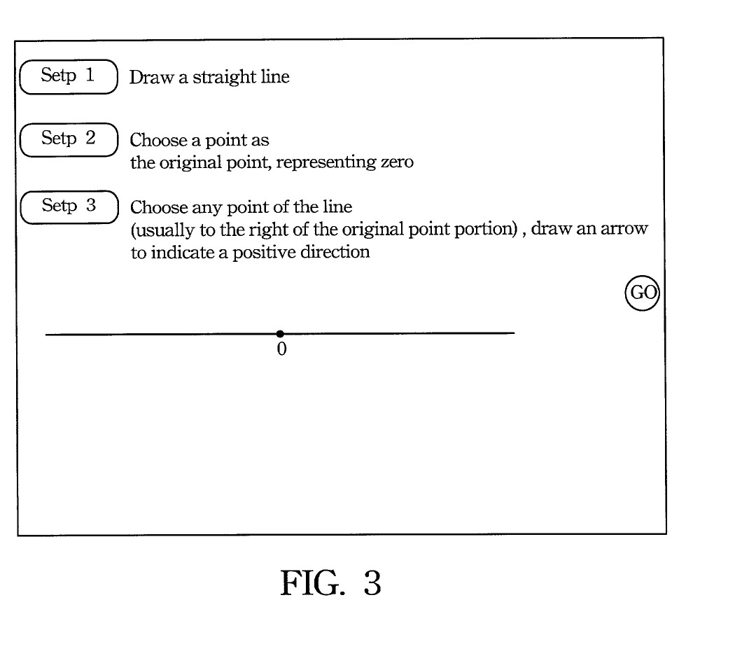

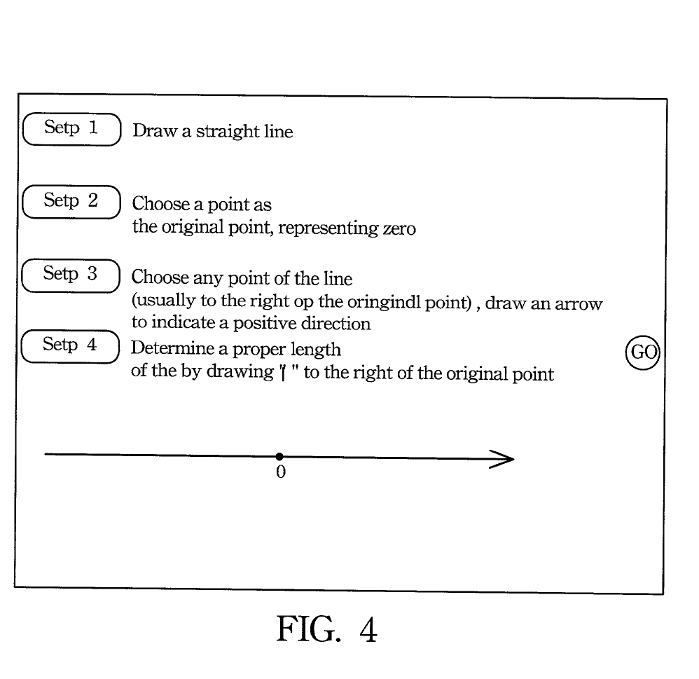

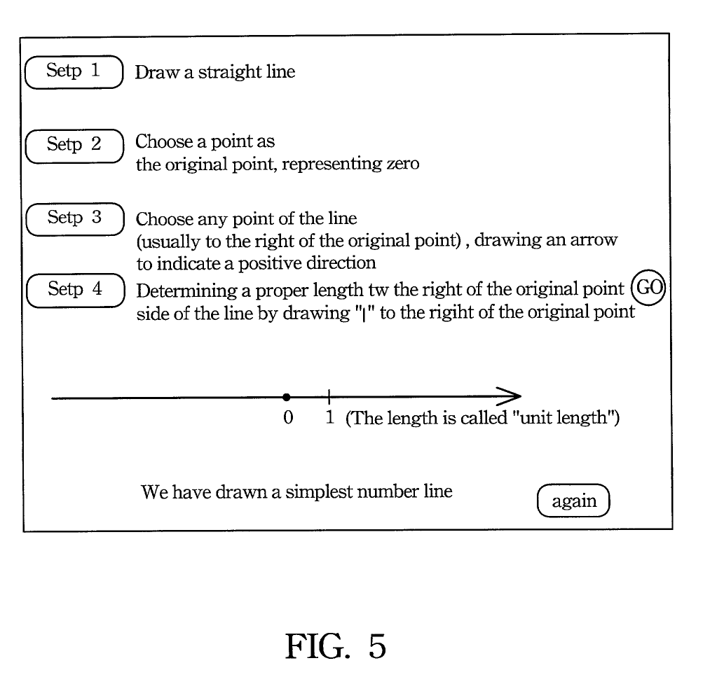

After the student presses the button “GO”, a line from left to right is gradually shown on the display. After the drawing of the straight line is completed, further information “Step 2 Choose a point as the original point, representing zero” is shown in the display as depicted in FIG. 2. The student is invited to press the button “GO”. Then, information “Choose any point of the line casually to the right of the original point, draw an arrow to indicate a positive direction” is provided on the display, as depicted in FIG. 3. The student is invited to press the button “GO”.As shown in FIG. 2, an appearance of a picture is displayed. After the button “GO” is pressed, an original point and a coordinate thereof are shown in the line, and step 3 is achieved. After the button “GO” is pressed, a “>” is shown at the right end of the line. Then information “Determine a proper length to the right of the original point by drawing “|” on the display, as depicted in FIG. 4. The student is invited to press the button “GO”. After the button “GO” is pressed, a “|” and the unit vector thereof are shown in the line to the right of the original point. Then, information “The length is called “unit length”. We have drawn a simplest number line Again” is provided on the display, as depicted in FIG. 5. A number line is completed. After it is completed, the student decides to repeat or not by himself or herself.

### EXAMPLE I

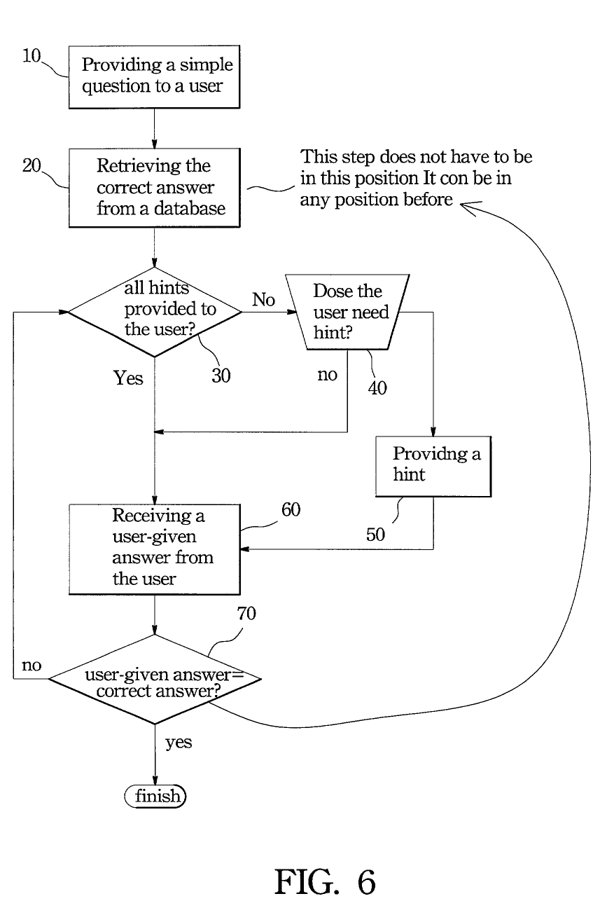

Referring to FIG. 6, a computer-implemented method for helping a learner practice by providing hints is described. In step 10, a simple question is provided to a learner. In steps 30 to 40, a decision is made on whether a hint is to be provided to the learner. In step 50, a hint is provided to the learner if the decision is “yes”. In step 60, a learner-given answer is received from the learner. In step 70, whether the learner-given answer is correct is checked.

Preferably, the step of making a decision on whether a hint is to be provided to the learner comprises a step of checking whether all hints have been provided to the learner (step 30), and comprises a step of checking whether the learner needs a hint, wherein the decision is “yes” if all hints have not been provided to the learner and if the learner needs a hint (step 40). More preferably, the step of checking whether all hints have been provided to the learner is performed before the step of checking whether the learner needs a hint. In steps 70 to 30, it returns to the step of making a decision on whether a hint is to be provided to the learner if the learner-given answer is incorrect. The method could further comprise a step of retrieving a correct answer for the simple question before the step of checking whether the learner-given answer is correct (step 20).

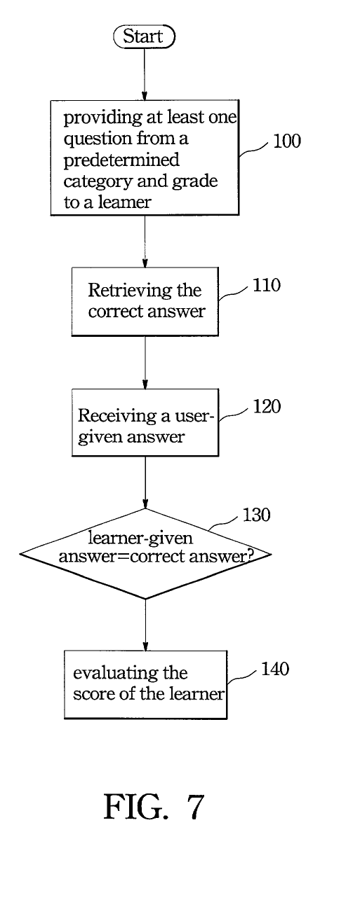

Referring to FIG. 7, a computer-implemented method for helping a learner practice wherein a plurality of simple questions are sorted into various grades is described. In step 100, at least one simple question of a grade is provided to a learner. In step 110, a learner-given answer is received from the learner. In step 130, whether the learner-given answer is correct is checked. In steps 130 to 100, it is returned to the step of providing at least one simple question based on the determination whether the learner-given answer is correct.

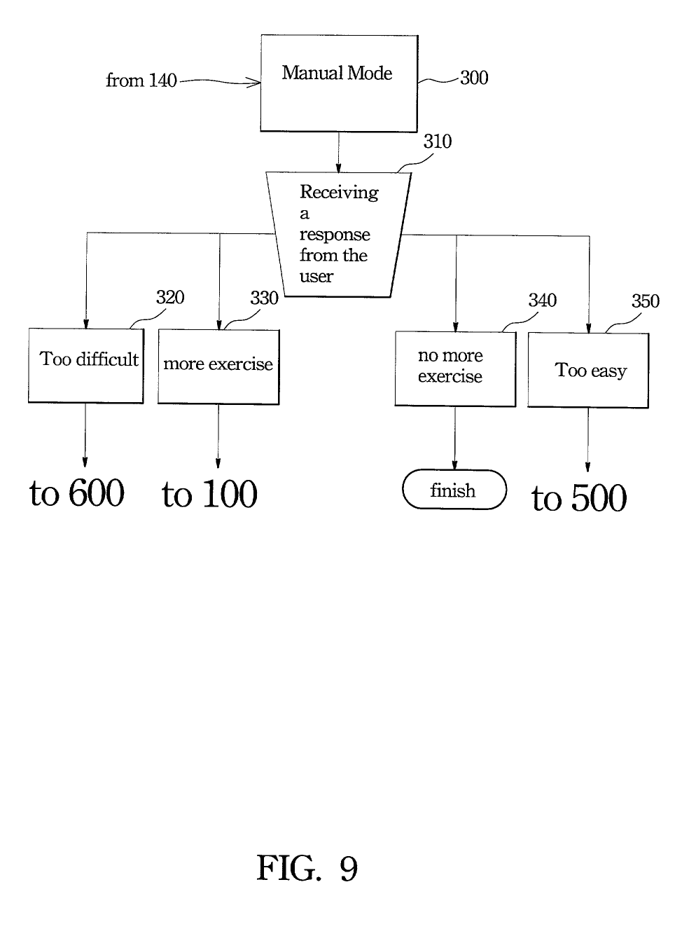

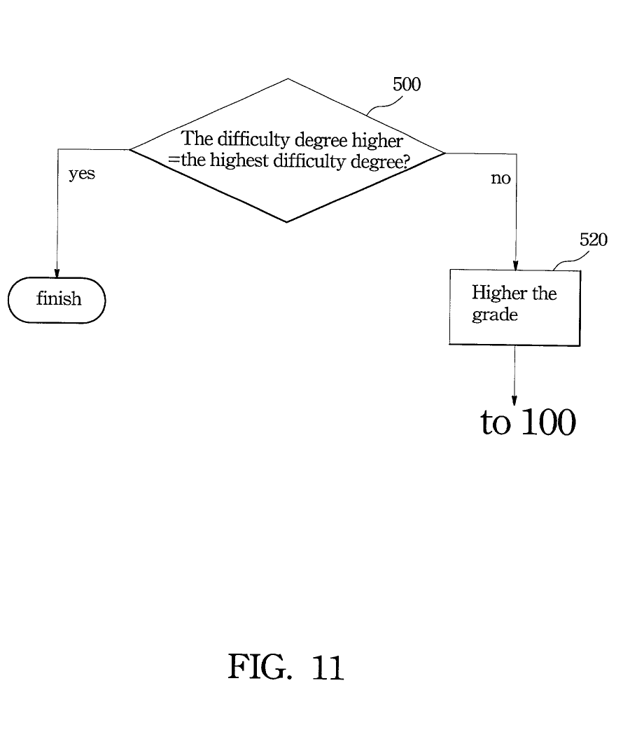

Referring to FIG. 9, from step 140 to step 300, a manual mode is provided. Thereafter, in step 310, a response is received from the learner wherein the response is one of “easy,” “fit,” and “difficult.” In step 350, if the response is “easy”, whether the grade to which the first simple question belongs reaches the highest grade is checked. In steps 350 to 500 (FIG. 11), the second simple question is provided from a higher grade than the first simple question is if the grade to which the first simple question belongs is not the highest grade. In step 330, the second simple question is provided from the same grade as the first simple question is if the response is “fit.”

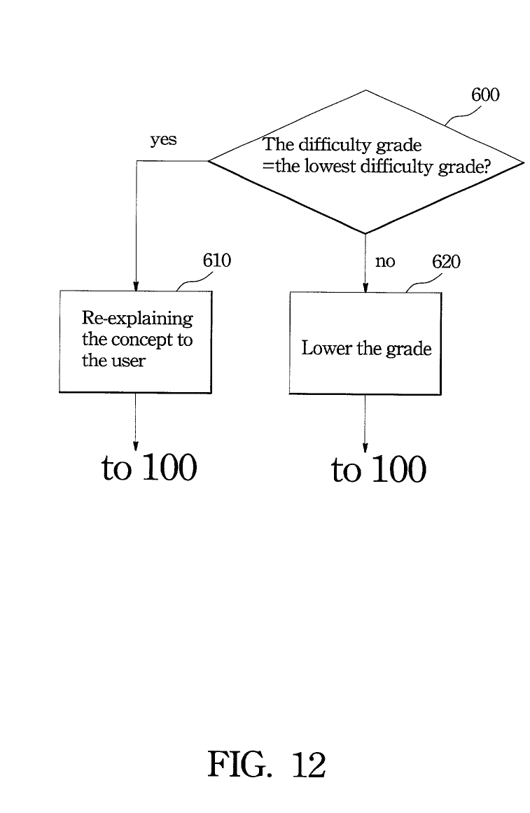

Referring to FIG. 12, it is further comprised a step of checking whether the grade to which the first simple question belongs reaches the lowest grade if the response is “difficult” (step 600). In step 620, the second simple question is provided from a lower grade than the first simple question is if the grade to which the first simple question belongs is not the lowest grade. The method may further comprise a step of explaining the concept of the simple question to the learner if the grade to which the first simple question belongs reaches the lowest grade (step 610).

Referring FIG. 7, in step 100, a plurality of simple questions are provided in the step of providing at least one simple question. The method may further comprise a step of evaluating the score of the learner before returning to the step of providing simple questions (step 140).

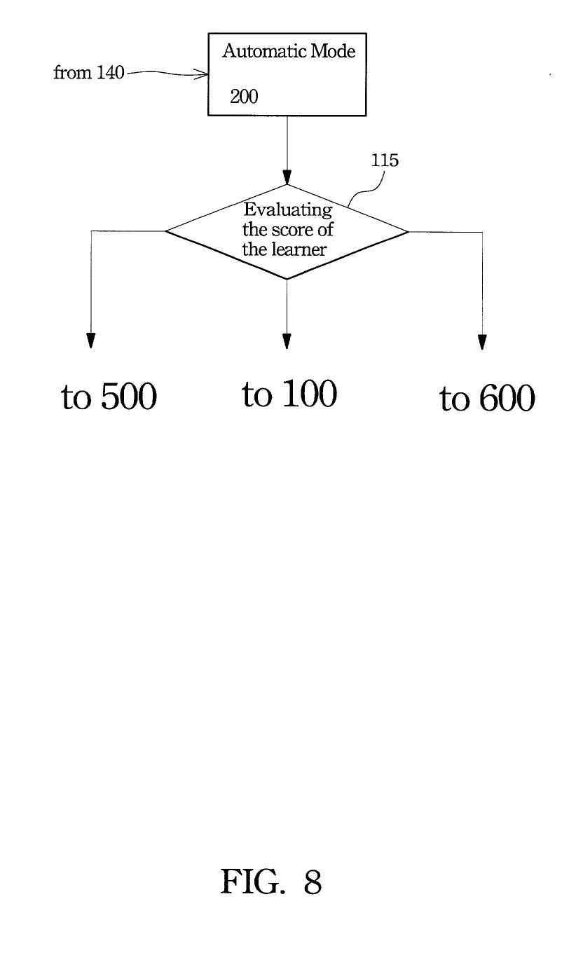

Referring to FIG. 8, the method may further comprising a step of checking whether the grade to which the first plurality of simple questions belong reaches the highest grade if the score is better than a pre-determined upper criterion (steps 210 to 500 (FIG. 11)).

Referring FIF. 11, in step 520, the second plurality of simple questions are provided from a higher grade than the first plurality of simple questions are if the grade to which the first plurality of simple questions belong is not the highest grade.

Turning to FIG. 8, in steps 210 to 100, the second plurality of simple questions are provided from the same grade as the first plurality of simple questions are if the score is between pre-determined upper and lower criteria.

Turning to FIG. 9, the method may further comprise a step of receiving a response from the learner if the score is better than a pre-determined upper criterion wherein the response is one of “easy,” “fit,” and “difficult” (step 310). The method may further comprise a step of checking whether the grade to which the first plurality of simple questions belong reaches the highest grade if the response is “easy” (steps 350 to 500).

Turning to FIG. 11, in step 520, the second plurality of simple questions are provided from a higher grade than the first plurality of simple questions are if not reaching the highest grade if the response is “easy.”

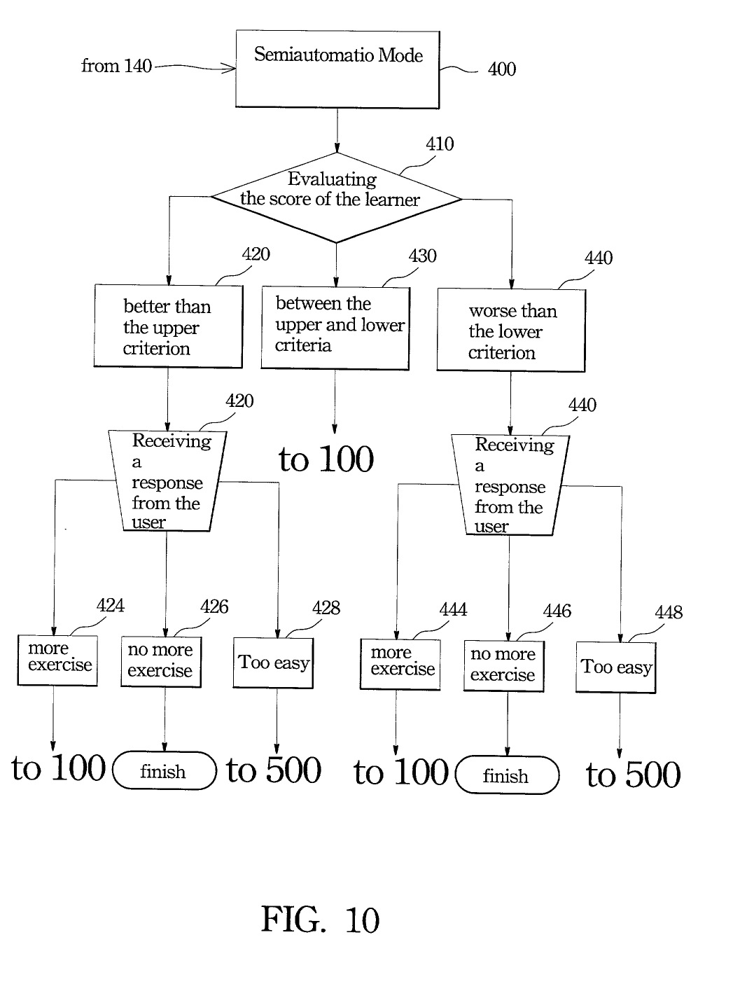

Turning to FIG. 10, the method may further comprising a step of receiving a response from the learner if the score is worse than a pre-determined lower criterion (steps 440 to 442). In step 448, if the response is “difficult”, whether the grade to which the first plurality of simple questions belong reaches the lowest grade is checked. In steps 448 to 600, the second plurality of simple questions are provided from a lower grade than the first plurality of simple questions are if not reaching the lowest grade if the response is “difficult.”

Turning to FIG. 10, in step 444, the second plurality of simple questions are provided from the same grade as the first plurality of simple questions are if the response is “fit.”

Referring FIG. 6, the method may further comprise a step of retrieving the correct answer for the simple question provided to the learner before the step of checking whether the learner-given answer is correct (step 20).

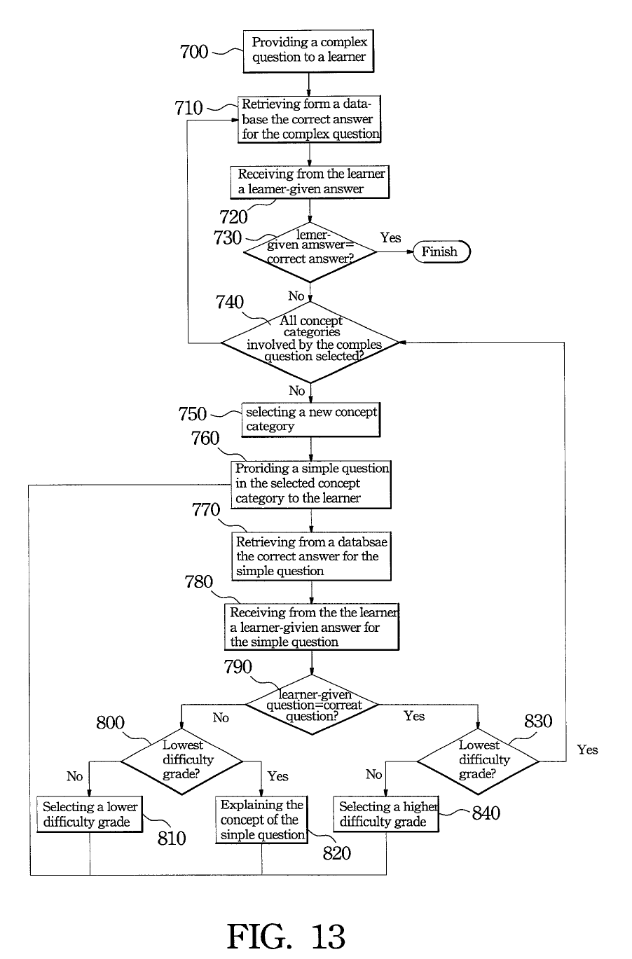

Referring FIG. 13, a computer-implemented method is described for helping a learner practice wherein a plurality of simple questions are sorted into a plurality of grades in a plurality of categories and a plurality of complex questions each include a plurality of components each falling in a target grade in a category. In step 700, a complex question is provided to a learner. In step 710, the method may further comprises a step of retrieving from a database the correct answer for the complex question. In step 720 a learner-given answer is received from the learner for the complex question. In step 730, whether the learner-given answer for the complex question is correct is checked. The method may further comprise a step of determining if all concept categories involved by the complex question selected (step 740. In step 750, if the learner-given answer is incorrect, one of the components of the complex question is selected. In step 760, a simple question is provided from the target grade in the category to which the selected component belongs. The method may further comprise a step of retrieving from a database the correct answer for the simple question (step 770). In step 780, a learner-given answer is received from the learner for the simple question. In step 790, whether the learner-given answer for the simple question is correct is checked. In step 810, if the learner-given answer for the simple question is correct, whether the grade to which the simple question belongs reaches the target grade is checked. In steps 830 to 740, it is turned to the component-selecting step if the grade to which the simple question belongs reaches the target grade. In step 840, a higher grade is selected and returning to the step of providing a simple question if the grade to which the simple question belongs does not reach the target grade. In step 800, if the learner-given answer for the simple question is incorrect, checking whether the grade to which the simple question belongs reaches the lowest grade. In step 820, the concept of the simple question is explained if the grade to which the simple question belongs reaches the lowest grade. In step 810, a lower grade is selected, and it is returned to the step of providing a simple question if the grade to which the simple question belongs does not reach the lowest grade.

### EXAMPLE II

A. Exercising Process

I. Auxiliary System for Interactive Learning

Introduction

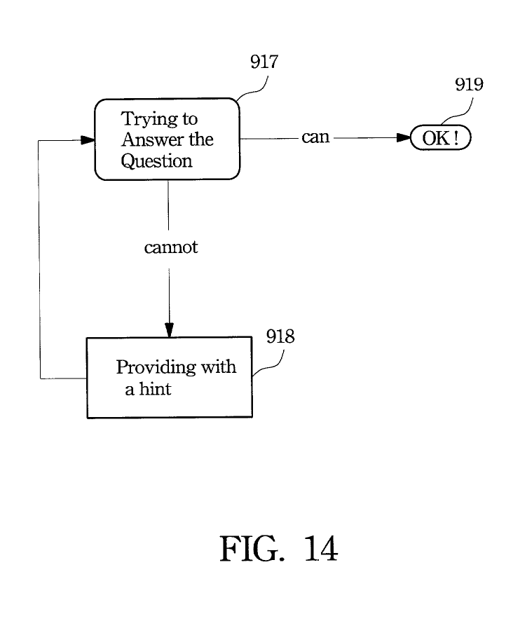

An ordinary student often cannot answer a question because of a small trap in the question, or because he lacks inspiration temporarily. In such a case, providing the student with a proper hint usually enables the student to answer the question. In the system, possible hidden traps are analyzed by one or more experts. The hints for the analyzed traps are respectively provided in accordance with the order of occurance. When a student meets a barrier, he or she can ask for hints from the system in sequence if necessary. FIG. 14 is a process flow schematically illustrating an operation for the present system.

Executive Method

1. One or more than one experienced experts analyze the questions in search of questions that may block the thoughts of the students, to find the traps in the questions, and then to make useful hints for the students to answer the questions in the system. Each blocking question is accompanied with one or more than one hints.

2. In step 917, a student is trying to answer a question, while a button of hint is disposed near the question blocking the thought of a student. After the student pushes the button to get the hint, he or she would re-answer the question by referring to the hint. In step 918, the student can get the next hint from the system until he has answered the question, if he or she cannot answer the question after receiving the first hint. In step 919, the student correctly answers the question. Such a system plays a role of a patient teacher to assist the student in answering questions.

II. Expert System for Stage-by-Stage Learning

Introduction

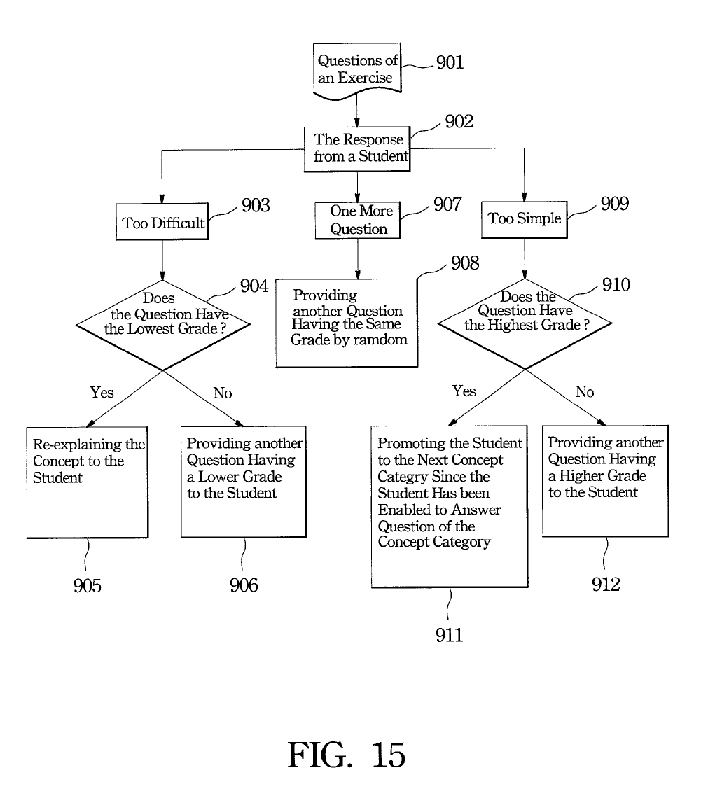

Questions of an exercise have different degrees of difficulty. In a learning process for a student to answer the questions, an experienced teacher first grade and/or categorize the questions according to the capability of the student, and increase the capability of the student in the learning process. The present system comprises all concepts and the questions thereof entirely categorized by one or more than one expert. By using those questions, the system instructs the student in a different rate of progress every time, according to the response from the student. FIG. 15 is another process flow schematically illustrating an operation for the present system.

Executive Method

1. One or more than one experienced and expert teachers particularly categorize all contents of a course into concept categories, and grade the concept categories questions in each concept category according to the difficulty thereof.

2. The questions of the course are classified according to the categories of the concepts, simultaneously graded according to the difficulty of the questions, and assigned with numbers individually. In each of the concept categories, the questions have the same style. Accompanied with the questions, the assigned numbers indicate their concept categories and difficult grades, respectively.

3. In step 901, the categorized questions are input into a computer database. By the input questions accompanied with concept categories and difficult grades, the system can instruct students with content teaching and question deducing. Such an instruction can be performed in accordance with different difficulty grades.

4. At the beginning of a class, a concept of the course is explained to a student by a system. After the concept has been explained, a question of the simplest grade of the concept category is provided to the student. Thereafter, the rate of progress for the student is adjusted according to the response from the student.

5. Every time the student has answered a provided question, a question, having a grade just higher than that of the originally provided question for one, is then provided by the system to the student (step 912), if he responses that the question is too simple (steps 902 and 909). The case indicates that the student is enable to answer the questions having a grade the same as that of the originally provided question. If the subsequently-provided question has the highest grade of the concept category, as shown in steps 190 and 911, the student would be promoted to the next concept education. Such promotion can be suggested and required by the system.

6. If the student responses that he wants to answer one more question having similar difficulty after he has answered the originally provided question (steps 902 and 907), another question, having a grade the same as that of originally provided question, is then provided to the student for skill enhancement. As shown in step 908, the second-provided question can be provided from a random selection by the system. The case indicates that the student is not skilled in such question.

7. If the student responses that the originally provided question is too difficult after he has answered the question (steps 902 and 903), another question, having a grade just lower than that of the originally provided question for one, is then provided to the student for more exercise (step 906). In step 904, the system would judge if the originally-provided question belongs to the lowest grade of the concept category. If the question originally provided belongs to lowest grade of the concept category, the concept will be re-explained to the student since the student does not understand the concept well enough, as shown in step 905.

III. Expert System for Comprehensive Teaching

Introduction

A basic question of a course can be easily categorized, but a comprehensive question, such as one of the questions in the end of a lesson, a chapter or a book, or questions for overall review, often relate to many concept categories. Such a comprehensive question is not easily categorized because it often involves other important concept(s) in addition to the major concept. An experienced teacher teaches a student with all those concepts individually, and instruct the student to answer the comprehensive questions after the student has fully understood those concepts.

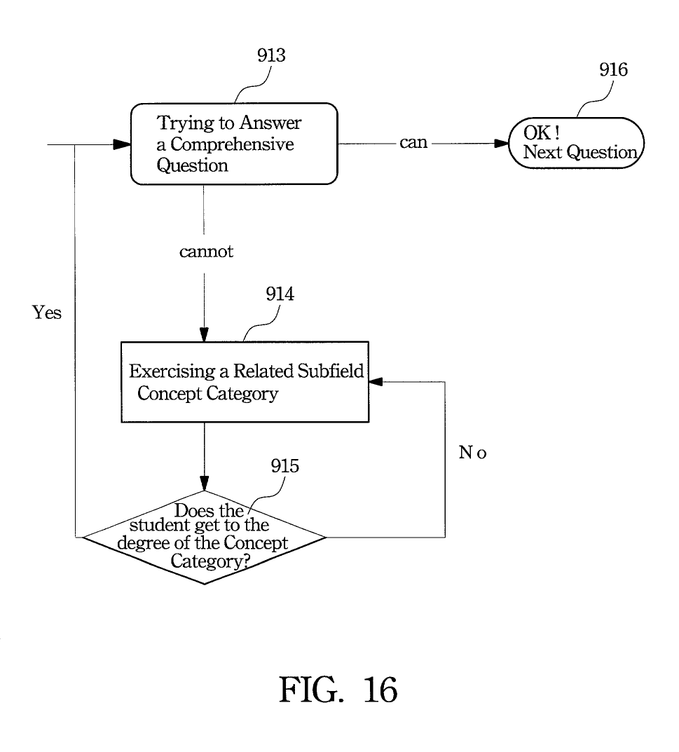

The present system comprises comprehensive questions which backgrounds have been analyzed to by one or more than experts. Each of the analyzed questions belongs to more than one concept categories arranged according to their importance in this question. Moreover, the sub-questions, related to each comprehensive question and located in different concept categories, are assigned their difficulty grades in their concept categories, respectively. Accordingly, when a student is blocked by a comprehensive question, he or she can be enhanced with every related concept category step by step until the comprehensive problem has been answered. FIG. 16 is the other process flow schematically illustrating an operation for the present system.

Executive Method

1. Comprehensive questions are categorized and graded by one or more than one experts. By doing so, each of the categorized questions belongs to more than one concept categories, and all concept categories are arranged according to their importance in this question. Moreover, each comprehensive question is accompanied with a plurality of numbers respectively indicating its concept categories and difficulty grades, and the concept categories are arranged in accordance with their importance in the questions.

2. If a student is blocked by a comprehensive question, as shown in steps 913 to 914, the system may process according to one of the following:

a. enhancing the student according to his or her weak point:

If a student cannot answer a comprehensive question after he or she has learned all related concept categories, the student may not fully understand every concept category. In such a case, the system can determine which concept category is the most difficult to the student according to the record of the past answering process, and then provides a question in the concept category to the student for skill enhancement (The skill-enhancement process is essentially the same as the description in the section of the system for stage-by-stage teaching). If the student still cannot answer the comprehensive question after he or she has fully understood the determined concept category, the student will be instructed to answer the questions in another related concept category for skill enhancement until he or she can answer the comprehensive question.

b. enhancing the student in an order according to the importance of each related concept category:

If the system has not enough record of the past answering process for the student, and therefore cannot determine which concept category is the most difficult to him or her, questions of the most important category having a related concept will be provided to the student for skill enhancement.

If the student still cannot answer the comprehensive question after answered the provided questions, it indicates that he or she cannot answer the comprehensive question is because of another concept category rather than the originally provided concept category. In such a case, the system will instruct the student to answer the questions of the next related concept category, wherein the concept category has importance less than the originally provided for one. The instructing steps are repeated in sequence until the student can answer the comprehensive question.

3. Theoretically, a student is enabled to answer a comprehensive question having a plurality of related concept categories if he or she has answered the general questions categorized in those concept categories, as shown in steps 915 to 913. However, if a student still cannot answer the comprehensive question after the above instructing steps are performed, he or she will be instructed as follows (steps 915 to 914):

a. Analyzing the concept categories related to the comprehensive question, and analyzing their difficulty degrees, to see if the concept categories are enough to support the comprehensive question, or to see if the grades of the concept categories need to be adjusted.

b. Reconsidering and adjusting the difficulty grades of the questions in each related concept category, thereby ensuring that every student who has answered the questions indeed understands the concept category.

The present invention has at least the following features:

1. It adequately utilizes the interaction property between a computer and a user; and

2. It makes a user feels that the system is specially designated only for him or her, and lets the user learn in a proper sequence.

Although the invention has been described in detail herein with reference to its preferred embodiment, it is to be understood that this description is by way of example only, and is not to be construed in a limiting sense. It is to be further understood that numerous changes in the details of the embodiments of the invention, and additional embodiments of the invention, will be apparent to, and may be made by, persons of ordinary skill in the art having reference to this description. It is contemplated that such changes and additional embodiments are within the spirit and true scope of the invention as claimed below.

claims:

1. A computer-implemented method for helping a learner practice by providing hints, the method comprising steps as follows:
providing a simple question to a learner;
making a decision on whether a hint is to be provided to the learner;
providing a hint to the learner if the decision is “yes;”
receiving a learner-given answer from the learner; and
checking whether the learner-given answer is correct.

2. A method in accordance with claim 1 wherein the step of making a decision on whether a hint is to be provided to the learner comprises following steps:
checking whether all hints have been provided to the learner; and
checking whether the learner needs a hint, wherein the decision is “yes” if all hints have not been provided to the learner and if the learner needs a hint.

3. A method in accordance with claim 2 wherein the step of checking whether all hints have been provided to the learner is performed before the step of checking whether the learner needs a hint.

4. A method in accordance with claim 1 wherein it returns to the step of making a decision on whether a hint is to be provided to the learner if the learner-given answer is incorrect.

5. A method in accordance with claim 1 further comprising a step of retrieving a correct answer for the simple question before the step of checking whether the learner-given answer is correct.

6. A computer-implemented method for helping a learner practice wherein a plurality of simple questions are sorted into various grades, the method comprising the steps of:
providing at least one simple question of a grade to a learner;
receiving a learner-given answer from the learner;
checking whether the learner-given answer is correct;
returning to the step of providing at least one simple question based on the determination whether the learner-given answer is correct.

7. The method in accordance with claim 6 further comprising a step of receiving a response from the learner wherein the response is one of “easy,” “fit,” and “difficult.”

8. The method in accordance with claim 7 further comprising a step of checking whether the grade to which the first simple question belongs reaches the highest grade if the response is “easy.”

9. The method in accordance with claim 8 wherein the second simple question is provided from a higher grade than the first simple question is if the grade to which the first simple question belongs is not the highest grade.

10. The method in accordance with claim 7 wherein the second simple question is provided from the same grade as the first simple question is if the response is “fit.”

11. The method in accordance with claim 7 further comprising a step of checking whether the grade to which the first simple question belongs reaches the lowest grade if the response is “difficult.”

12. The method in accordance with claim 11 wherein the second simple question is provided from a lower grade than the first simple question is if the grade to which the first simple question belongs is not the lowest grade.

13. The method in accordance with claim 11 further comprising a step of explaining the concept of the simple question to the learner if the grade to which the first simple question belongs reaches the lowest grade.

14. The method in accordance with claim 6 wherein a plurality of simple questions are provided in the step of providing at least one simple question.

15. The method in accordance with claim 14 further comprising a step of evaluating the score of the learner before returning to the step of providing simple questions.

16. The method in accordance with claim 15 further comprising a step of checking whether the grade to which the first plurality of simple questions belong reaches the highest grade if the score is better than a pre-determined upper criterion.

17. The method in accordance with claim 16 wherein the second plurality of simple questions are provided from a higher grade than the first plurality of simple questions are if the grade to which the first plurality of simple questions belong is not the highest grade.

18. The method in accordance with claim 15 wherein the second plurality of simple questions are provided from the same grade as the first plurality of simple questions are if the score is between pre-determined upper and lower criteria.

19. The method in accordance with claim 15 further comprising a step of checking whether the grade to which the first plurality of simple questions belong reaches the lowest grade if the score is worse than a pre-determined upper criterion.

20. The method in accordance with claim 19 wherein the second plurality of simple questions are provided from a lower grade than the first plurality of simple questions are if the grade to which the first plurality of simple questions belong is not the lowest grade.

21. The method in accordance with claim 19 further comprising a step of explaining the concept of the simple questions to the learner if the grade to which the first plurality of simple questions belong reaches the lowest grade.

22. The method in accordance with claim 15 further comprising a step of receiving a response from the learner if the score is better than a pre-determined upper criterion wherein the response is one of “easy,” “fit,” and “difficult.”

23. The method in accordance with claim 22 further comprising a step of checking whether the grade to which the first plurality of simple questions belong reaches the highest grade if the response is “easy.”

24. The method in accordance with claim 23 wherein the second plurality of simple questions are provided from a higher grade than the first plurality of simple questions are if not reaching the highest grade if the response is “easy.”

25. The method in accordance with claim 22 wherein the second plurality of simple questions are provided from the same grade as the first plurality of simple questions are if the response is “fit.”

26. The method in accordance with claim 15 further comprising a step of receiving a response from the learner if the score is worse than a pre-determined lower criterion.

27. The method in accordance with claim 26 further comprising a step of checking whether the grade to which the first plurality of simple questions belong reaches the lowest grade if the response is “difficult.”

28. The method in accordance with claim 27 wherein the second plurality of simple questions are provided from a lower grade than the first plurality of simple questions are if not reaching the lowest grade if the response is “difficult.”

29. The method in accordance with claim 27 further comprising a step of explaining the concept of the simple questions to the learner if the grade to which the first plurality of simple questions belong reaches the lowest grade if the response is “difficult.”

30. The method in accordance with claim 26 wherein the second plurality of simple questions are provided from the same grade as the first plurality of simple questions are if the response is “fit.”

31. The method in accordance with claim 6 further comprising a step of retrieving the correct answer for the simple question provided to the learner before the step of checking whether the learner-given answer is correct.

32. A computer-implemented method for helping a learner practice wherein a plurality of simple questions are sorted into a plurality of grades in a plurality of categories and a plurality of complex questions each include a plurality of components each falling in a target grade in a category, the method comprising the following steps:
providing a complex question to a learner;
receiving a learner-given answer from the learner for the complex question;
checking whether the learner-given answer for the complex question is correct;
if the learner-given answer is incorrect, selecting one of the components of the complex question and executing the following steps:
providing a simple question from the target grade in the category to which the selected component belongs;
receiving from the learner a learner-given answer for the simple question;
checking whether the learner-given answer for the simple question is correct;
if the learner-given answer for the simple question is correct, checking whether the grade to which the simple question belongs reaches the target grade and performing the following steps:
returning to the component-selecting step if the grade to which the simple question belongs reaches the target grade;
selecting a higher grade and returning to the step of providing a simple question if the grade to which the simple question belongs does not reach the target grade;
if the learner-given answer for the simple question is incorrect, checking whether the grade to which the simple question belongs reaches the lowest grade and performing the following steps:
explaining the concept of the simple question if the grade to which the simple question belongs reaches the lowest grade; selecting a lower grade and returning to the step of providing a simple question if the grade to which the simple question belongs does not reach the lowest grade.
